(19) United States
(12) Patent Application Publication
(10) Pub. No.: US 2018/0346309 A1
(43) Pub. Date: Dec. 6, 2018

(54) A SEPARABLE CONTAINER FOR HOUSING AND DISPENSING BEVERAGES UNDER PRESSURE

(71) Applicant: KAMBOURIS SHARES PTY LTD, Mildura (AU)

(72) Inventors: Ambrosios KAMBOURIS, Mildura (AU); Mark BAYLY, Mildura (AU)

(21) Appl. No.: 15/778,686

(22) PCT Filed: Nov. 24, 2015
(86) PCT No.: PCT/AU2015/000711

§ 371 Date: May 24, 2018

(30) Foreign Application Priority Data
Nov. 24, 2014 (AU) 2014904820

(51) Int. Cl. B67D 1/04; B65D 21/06; B65D 21/02; B65D 45/30; B67D 1/08

(52) U.S. Cl. CPC B67D 1/0462; B65D 21/06; B67D 1/0801; B65D 45/30; B65D 21/0231

(57) ABSTRACT

A separable container including a top and a base joined by a locking ring, the top and the base attached to the ring through locking tabs adapted to sealingly attach the top to the base through the ring. The base is of a converging shape allowing bases to be nestled within each other when separated from the top for easier transport when empty. When assembled the container typical includes a bladder to hold a liquid to be dispensed and a pressuring means enables the liquid to be dispensed.

### FIELD OF THE INVENTION

The present invention relates generally to a container adapted to be pressurised and in some cases housing a bladder containing a beverage, the pressurisation enabling the beverage to be dispensed. The container is pre-packaged and delivered to an end user when the pressurisation is typically activated. When the beverage has been dispensed the container can be disassembled so that it can be nested allowing for easier transport to be re-used.

### BACKGROUND OF THE INVENTION

Beverages that are dispensed in larger volumes, such as beer, typically are delivered to premises, such as taverns and pubs, in kegs. When they are empty they are sent back to be re-used but in doing so even though they are empty they occupy the same transport space. At times they need to be stored at the tavern where when empty they occupy valuable space.

It is an object of the present invention to provide for a beverage dispensing container that is internally pressurised but can be disassembled when empty and/or to provide the public with a useful alternative.

### SUMMARY OF THE INVENTION

Therefore in one form of the invention there is proposed a separable container including a top and a base joined by a locking ring, the top and the base attached to the ring through locking tabs adapted to sealingly attach the top to the base through the ring.

In preference the base is of a converging shape allowing bases to be nestled within each other when separated from the top.

In preference when assembled the container includes a bladder to hold a liquid to be dispensed.

In preference the container further includes a gas pressurising means adapted to pressurise the container for the dispensing of fluid within the container.

In preference the gas pressurising means is located within the container.

In preference the gas pressurising means is located external to the container.

In preference the container includes a depressurising valve to enable the container to be depressurised.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

Reference will now be made, by way of example only, to the accompanying drawings.

FIG. 1 is a front view of the assembled container embodying the present invention;

FIG. 2 is the exploded view of the container illustrated in FIG. 1;

FIG. 3 illustrates the container partially assembled;

FIGS. 4, 4a and 4b illustrate the details of the top assembly of the container;

FIG. 5 is a top view of the top assembly;

FIGS. 6 and 6a are a cross-sectional view and a detailed partial view of the container as in FIG. 1 when in an unassembled configuration;

FIGS. 7 and 7a is the view as in FIGS. 6 and 6a but when in an assembled configuration;

FIG. 8 illustrates two containers stacked when in an assembled configuration;

FIG. 9 illustrates two top assemblies when in a disassembled arrangement; and

FIG. 10 illustrates two bases when in a disassembled and nested configuration.

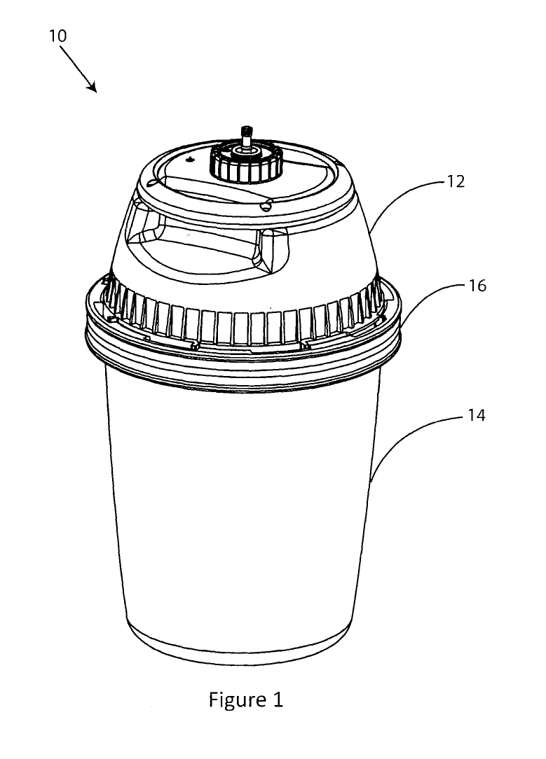

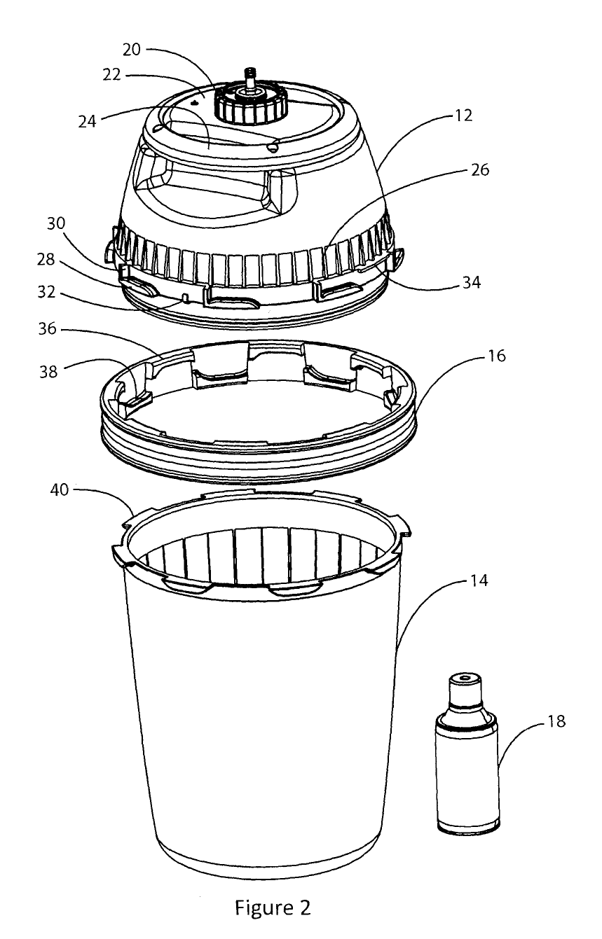

### DRAWING LABELS

The drawings include items labeled as follows:
10 container
12 top
12a second top
14 base
14a second base
16 locking ring
18 pressurised can
20 valve
22 top surface
24 carry handles
26 strengthening ribs
28 top locking tab
30 top locking tab end
32 snap projection
34 top tab
36 ring top locking tab
38 ring base locking tab
40 base tab

### DETAILED DESCRIPTION OF THE INVENTION

The following detailed description of a preferred embodiment of the invention refers to the accompanying drawings. Wherever possible, the same reference numbers will be used throughout the drawings and the following description to refer to the same and like parts. As used herein, any usage of terms that suggest an absolute orientation (e.g. “top”, “bottom”, “front”, “back”, “horizontal”, etc.) are for illustrative convenience and refer to the orientation shown in a particular figure. However, such terms are not to be construed in a limiting sense as it is contemplated that various components may in practice be utilized in orientations that are the same as, or different than those, described or shown. Dimensions of certain parts shown in the drawings may have been modified and/or exaggerated for the purposes of clarity or illustration.

Thus illustrated in the Figures is a container 10 including a top 12 and base 14 that are adapted to be connected through locking ring 16. In use the container includes a beverage bag (not shown) housing a beverage to be dispensed. It is to be understood that the beverage bag is only a preferred embodiment and the container may not include a bladder for a liquid.

Typically the beverage is carbonated, such as soft drink or beer, and in order to ensure that as the beverage is dispensed and the bag gets smaller that the beverage keeps its characteristics, the internal pressure on the bag is to be kept at a desired pressure that is typically greater than the atmospheric pressure. This is achieved by including a pressurised can 18 within the container that is engineered to keep the internal pressure of the container at a pre-set pressure, typically greater than the atmospheric pressure. Of course it is to be understood that the source of pressurisation may be achieved by other means. For example the source of pressurisation may be from an external gas source.

The purpose of this invention is not the engineering of such a can, but rather teaching a container that can be pressurised and maintain the internal pressure and yet can be disassembled when needed to do so for easier transport and to be able to re-use the container.

The top 12 includes a valve 20 that is well known in the industry and can be used to dispense the liquid and also includes a release mechanism to release any pressure in the container when the entire beverage has been dispensed (or at any other time). Being well known in the arts it will not be discussed further.

The top includes a top surface 22 and carry handles 24. These would be useful when the container is going to be of a large size, say more than 20 litres (and can be up to 50 litres), and assists in moving the container around. Strengthening ribs 26 provide structural support for the top 12. The top includes a top locking tab 28 (typically curved) including an end 30. Snap projection 32 is used initially to attach the locking ring 16 to the top 12 so that it does not come off. Of course other ways of keeping the ring 16 attached to the top 12 may equally well be employed. Once the ring 16 is attached to the top 12 this need not be done again even when the container is re-used.

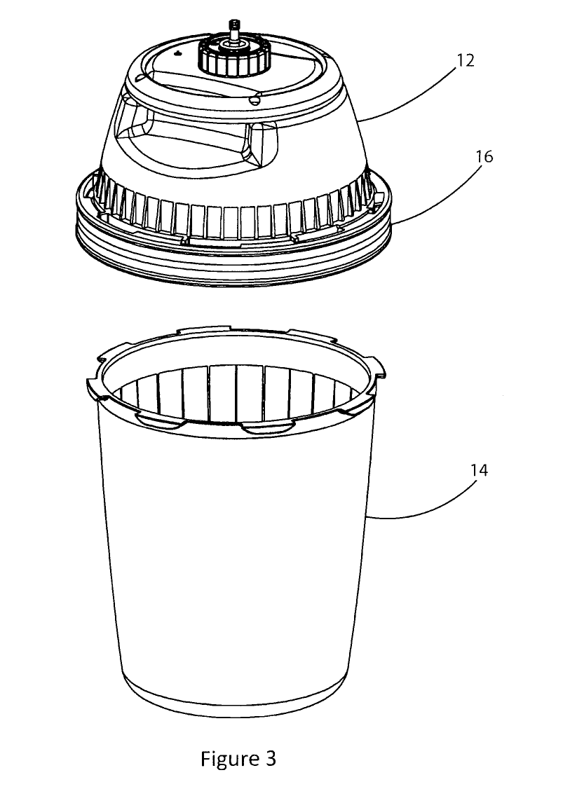

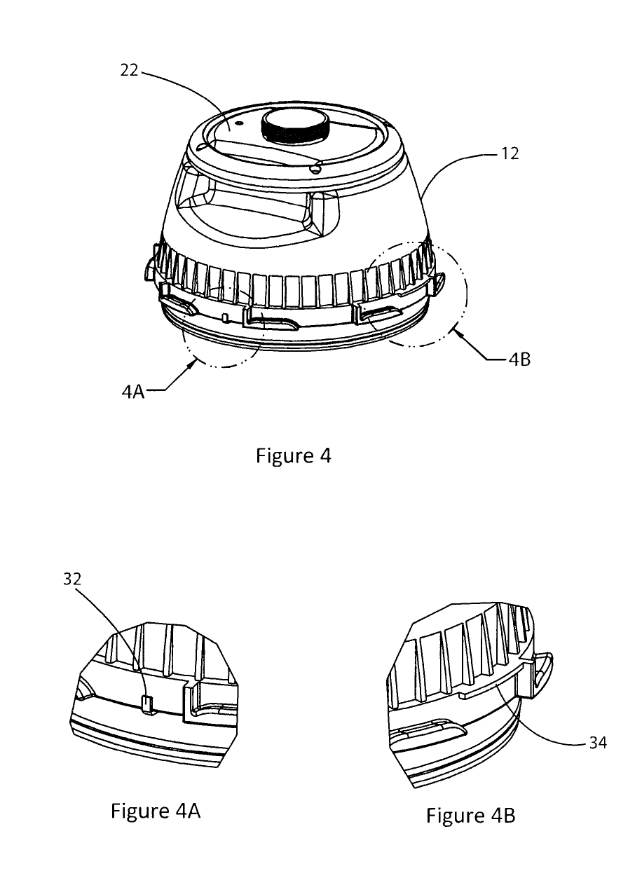

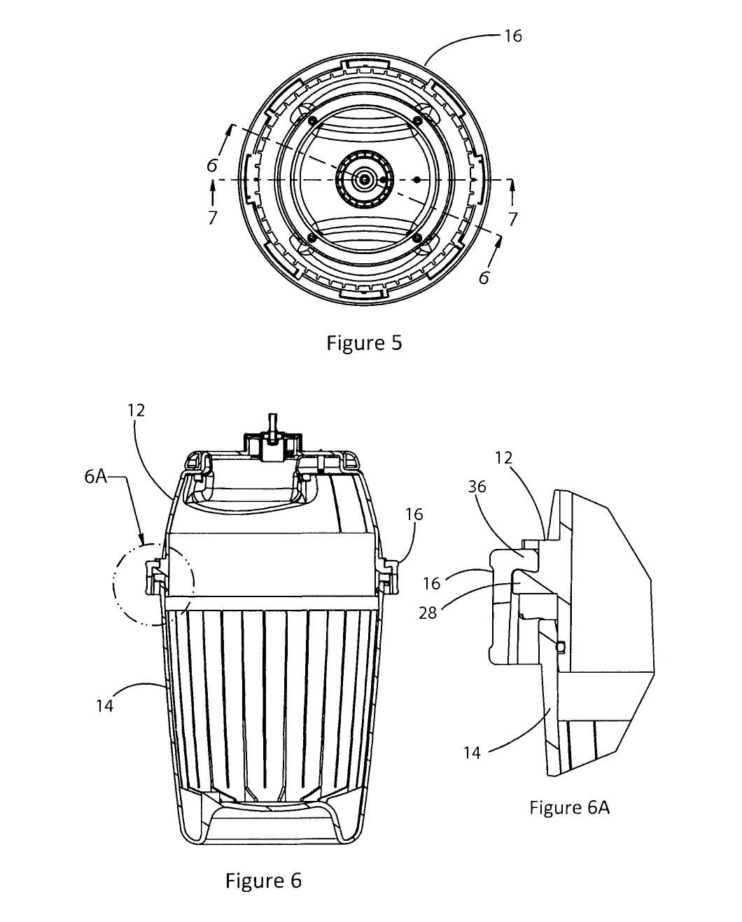

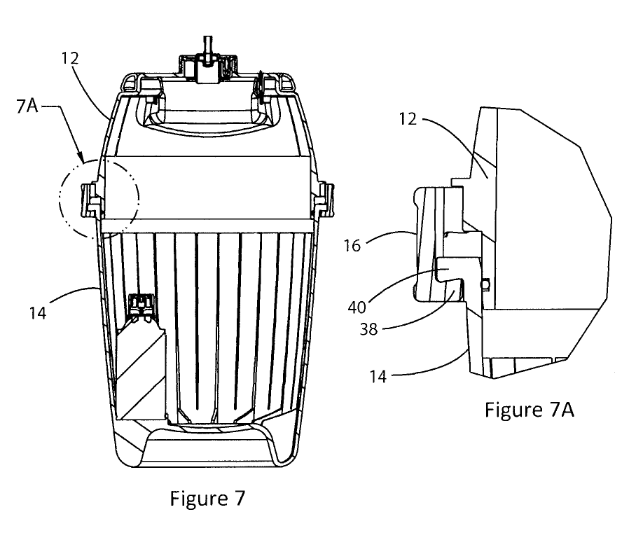

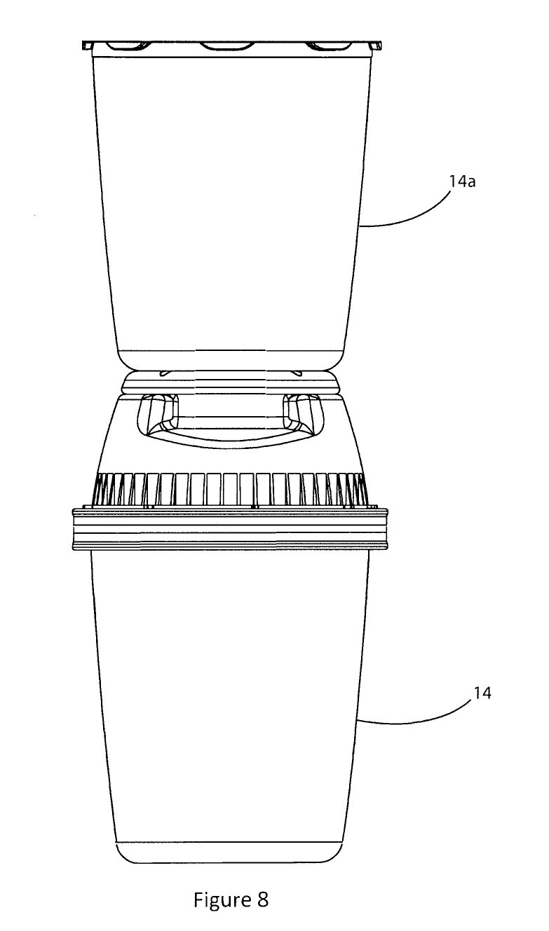

A rotation of the locking ring, typically through 22 degrees, then locks the top locking tab 28 to the ring top locking tab 36 joining the top 12 to the ring 16. Top tab 34 stops the locking ring 16 from moving up. When the top 12 and the ring 16 have been locked together, as illustrated in FIG. 3, they are attached to the base 14 using a similar design.

In use, the can pressurises the container and the top and the base will pull apart, typically by 10 mm, and will pull against the locking tabs. The curved locking tabs prevent the ring 16 from turning once the container 10 is pressurised. The ring 16 will thus feel loose until the container is pressurised.

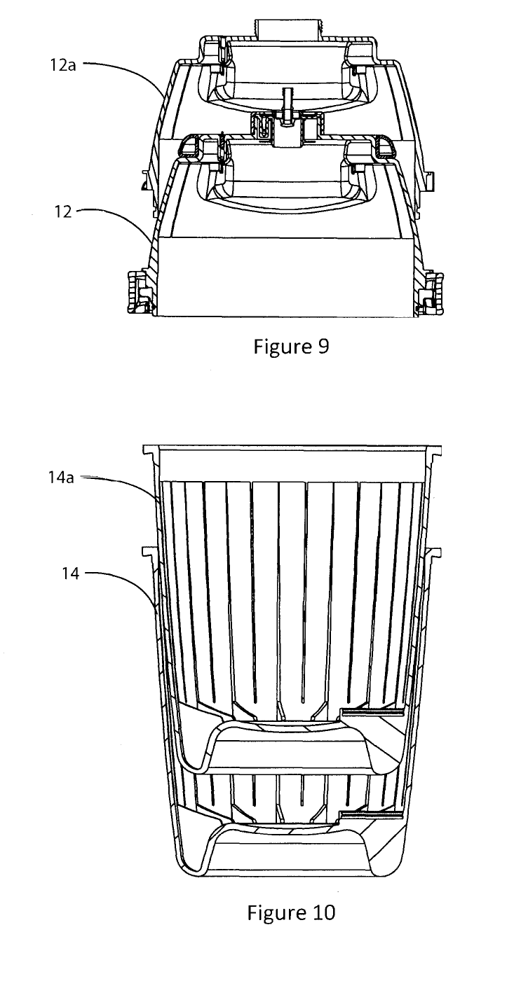

When the container is empty it can be de-pressurised using the valve 20. The top and the bottom can now be pushed together and the locking ring rotated anti-clockwise to release the base from the top and ring. This is not to say that a container may ne be constructed so that the rotation of the elements is in the opposite direction. The base and the top assembly (consisting of the top and the ring) can be then transported for re-use and can be stored in a nesting position as illustrated in FIGS. 9 and 10. The can be easily removed for disposal as can the valve and the beverage bag (not shown).

Although not shown it is to be understood that other features such as handles may be provided on the container for easier handling.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

It is to be understood that the invention is directed to a container that can be separated and that when assembled can be pressurised wither through internal or through external means.

In the present specification and claims (if any), the word “comprising” and its derivatives including “comprises” and “comprise” include each of the stated integers but does not exclude the inclusion of one or more further integers.

1. A separable container including a top and a base joined by a locking ring, the top and the base attached to the ring through locking tabs, wherein the locking tabs sealingly attach the top to the base through the ring.

2. The separable container as in claim 1 wherein the base is of a converging shape allowing bases of a plurality of identical containers to be nestled within each other when each of those bases of the plurality of identical containers are separated from an associated top thereof.

3. The separable container as in claim 1 that when assembled includes a bladder to hold a liquid to be dispensed.

4. The separable container as in claim 1 further including a gas pressurizing means adapted to pressurize the container for the dispensing of fluid within the container.

5. The separable container as in claim 4 wherein the gas pressurizing means is located within the container.

6. The separable container as in claim 4 wherein the gas pressurizing means is located external to the container.

7. The separable container as in claim 1, further comprising depressurizing valve to enable the container to be depressurized.
